(19) United States
(12) Patent Application Publication
(10) Pub. No.: US 2009/0248202 A1
(43) Pub. Date: Oct. 1, 2009

(54) MULTI-JOINT STRUCTURE, MOUNTING TOOL USING IT, SYSTEM AND HUMAN MACHINE INTERFACE

(76) Inventors: Koichi Osuka, Kyoto (JP); Shinobu Nakagawa, Kobe (JP); Takashi Wada, Kobe (JP); Yasuteru Kitada, Kobe (JP); Kenji Kusunoki, Kobe (JP)

Correspondence Address: OGILVIE LAW FIRM, 2552 South Wilshire Circle, SALT LAKE CITY, UT, 84109, US

(21) Appl. No.: 12/402,544

(22) Filed: Mar. 12, 2009

(30) Foreign Application Priority Data
Aug. 31, 2006 (JP) JP 2006-234946

(51) Int. Cl. G06F 19/00

(52) U.S. Cl. 700/245

(57) ABSTRACT

To manually and optionally change length of a multi-joint structure, the multi-joint structure of the present invention is constituted so that variation detection sensor such as potentiometers is provided on connecting parts between each of joints, one or a plurality of the sensors are assumed to be a unit of the group, the signals of the sensors are captured by signal processing parts in each unit of the group, the parts between the signal processing parts are connected to the communication network and the signal processing part connected to the communication network computes and processes in accordance with signal data of the sensors, and it is constituted to output moving quantity and vector when the joints move to translate and rotate by detecting variation of the connecting parts between the joints at real time when shape of the multi-joint structure is deformed.

### BACKGROUND OF THE INVENTION

The present invention is a technology concerning the recognition means to install the multi-joint structure that connects or separates one joint unit or more and is composed in the life, the robot, and the machine, etc., and to identify the position, movement, and shape, etc.

Moreover, the technology of the multi-joint structure automatically or manually that enables the separation and the connection of every 1 piece or several.

The present invention is a technology that recognizes the position of the hand, the foot, and the head of the human body by assuming that the multi-joint structure can be connected with the multistep by using one connected divergence means or more.

Moreover, the present invention is a technology that enables the extension, development in respect, and development with the mesh structure, etc. by assuming the multi-joint structure to be able to connect multi steps by using one connected divergence means or more. In addition, the present invention is a technology that enables the multi-joint structure to drive and to be transformed by adding the actuator means to connected part of the multi-joint structure.

Moreover, the present invention is a technology concerning positional identification by the cooperation of a cable technology and a wireless technology. For instance, the present invention can be applied to the robot for a special environment. That is, the multi-joint structure that can be moved is made to go into it in the struck building that collapses due to the large-scale earthquake etc., and it can search out the person buried in toles and pebbles.

### BACKGROUND ART

Conventionally, a complex expensive means was used. For instance, the encoder is used and the refractive index of the arrival and the optical fiber for the driving shaft is used, to identify present location and the shape of the measuring object where it rotates, and the curve etc. move complexly.

In the application for Patent Application No. JP2005-166558, the position, movement, and the shape etc. of the multi-joint structure are enabled to be identified in at a low price and high accuracy by installing the potentiometer in each joint. However, the length of the multi-joint structure was too long compared with a necessary amount of the object, too short, and application was difficult. This is the 1st problem of conventional technology.

The divergence means in the application for Patent Application No. JP2005-166558 cannot identify the position on a complex mesh structural side. In addition, the divergence means cannot not be transformed and be driven autonomous. This is the 2nd problem of conventional technology.

Moreover, when the disaster such as the large-scale earthquakes occurs, prompt life rescue work is needed. In the building in which it is struck (subway, underground shopping center, and skyscraper, etc.), it is extremely risky, and expected the support of the life rescue work by the robot. A prompt information gathering immediately after generation of the disaster is important for executing a prompt life rescue. It is considered that making to highly effective and making to high accuracy by a high-speed, decentralized information gathering reduce damage afterwards. It increases the generation probability of the secondary disaster that the person gathers information by a dangerous space in the struck building.

Therefore, it is hoped for plural robots to run at high speed in the building, and to be able to do a high-speed, decentralized information gathering.

Conventionally, the robot that searches for the victim is researched. For instance, the rescue robot is a robot that searches for the victim by making good use of the multi degree of freedom manipulator while removing the obstacle under toles and pebbles of the struck building etc.

Moreover, there is patent document 1 as a search robot system that can achieve efficient rescue operation. This search robot system divides one search space into plural meshes, and arranges the search robot of each mesh. As a result, it searched for the search area in the stricken area etc. in the total range, victim's position is understood accurately, and rescue operation can be done efficiently.

Moreover, the search activity can be achieved with a cheap, small robot. As a result, it can search widely through a small space of the obstacle.

However, the search robot of each mesh is arranged by using the flight means by the drive of the wing for the technology shown in patent document 1. Therefore, the search robot searches primarily along the surface of the obstacle. It cannot search for the search robot by invading from the space on the surface to the inside of the obstacle.

Therefore, it was difficult in the close spaces such as the subway, underground shopping centers, and skyscrapers to collect information on the confined victim promptly.

Moreover, the robot of the crawler type is known (For instance, see patent document 2-patent document 4). The robot of the crawler type is controlled remotely by a wireless communication or the cable communication, invades in the obstacle, and searches. The robot of the crawler type searches for (no adjustment place under toles and pebbles of the struck building etc.

However, each robot may not collect victim's information cooperatively high-speed and distributing. This is the 3rd problem of conventional technology.

[Patent documents 1] JP2003-339896A

[Patent documents 2] JP2004-188581A

[Patent documents 3] The application patent No. 2004-157977

[Patent documents 4] JP97-142347A

### DISCLOSURE OF THE INVENTION

### Problem to be Solved by the Invention

In light of the above-mentioned problems, the 1st technical problem of this invention is enabling change of the length of multi-joint structure arbitrarily manually. It is good also as division of a joint unit being possible per piece. It may be made the composition and the means which is automatically divided into suitable length and is connected by automatic control.

The 2nd technical problem of this invention is that connection of plural multi-joint structure and divergence unit by the mesh structure is enabled. The multi-joint structure connects, plural diverging divergence units connect with the multi-joint structure, the further divergence unit and the multi-joint structure connect, and the mesh structure is formed.

For instance, when the movement of the human body is identified, the composition in which the first divergence unit is installed in the waist, the multi-joint structure that expands to hands and feet respectively is installed, the divergence unit previously connected is installed in addition, and the multi-joint structure that expands from the divergence unit in each finger is installed.

Moreover, positional identification and the movement of plural multi-joint structures set up in the sea and objects connected with it are recognized by using the multi-joint structure that composes the side structure including the mesh structure.

The 3rd problem of the present invention is achievement of the positional identification means by the area adjustment between cooperation of a wireless technology that can communicate the cable technology such as multi-joint structures and under the environment scattering or wireless communications. Plural robots are able to half autonomous run the same average degree of the speed as human walks promptly while excluding evasion of to obstacle, getting over, and a light thing by using the technology in the close spaces such as the subway home (the examination of tickets is included) and underground shopping centers and skyscrapers (the stairs and the door are included).

Moreover, the 4th problem of the present invention is to monitor the running route of plural robots, and to do the mapping to Geographic Information System as for information on the sensor including plural images.

That is, the present invention aims to provide the device. The device can search for the victim by plural robots that move promptly in the building of the stairs and doors in the subway station, the underground shopping center, and the airport and the skyscraper, etc., and collect sensor information on image information etc. to the decided point and the route based on the GIS map in the building high-speed and distributing it.

### Means for Solving the Problem

To achieve the above-mentioned purpose, the multi-joint structure of claim 1 of the present invention is characterized in that; it is constituted to output moving quantity and vector when the joint unit move to translate and rotate by detecting variation of the connecting parts between the joints at real time when shape of the multi-joint structure is deformed, constituted so that variation detection sensor such as potentiometers is provided on connecting parts between each of joints, one or a plurality of the sensors are assumed to be a unit of the group, the signals of the sensors are captured by signal processing parts in each unit of the group, the signal processing parts are connected to the communication network and the operation processing part connected to the communication network computes and processes in accordance with signal data of the sensors, to manually and optionally change length of a multi-joint structure.

As for the multi-joint structure of the present invention, plural unit devices (It is called the joint unit in this specification) are connected like the length scale through connected part, and whole shape is formed. The variation detection sensor such as potentiometers is installed in connected part between joint units, and each joint unit can detect and measure the position and the movement of the adjoining joint unit relatively. The output signal from the variation detection sensor is taken into the signal processing part in each group.

Here, the purpose of assuming the group unit is to evade the necessity for forming the signal processing part to each joint unit. Whole of multi joint structure shape, using the detection signal from all sensors of the multi joint structure, is calculated by the processing operation part's that is connected with the communication network between the signal processing parts, and connected with the communication network.

A point of the present invention is the following. First of all, when whole of multi-joint structure shape is transformed, the variation in connected part between joint units is in realtime detected. Next, when the keep abreast of and the rotation move, the amount of the movement and the vector of connected part between joint units are output. The keep abreast of in connected part between joint units is that the ranging joint follows in the straight line here. The rotation movement is that the ranging joint is a right and left, and changes the relative position relation up and down. The twist of connected part between joint units can be detected, and be output similarly.

A variety of applied devices described as follows can be designed by using the amount of the movement and the vector the keep abreast of and rotation movements in connected part between joint units.

The multi-joint structure of claim 2 of the present invention is characterized in that, is composed by tubular or cylindrical shape, and comprises the power line and/or the signal line internally.

Since the power line and the signal line were able to be built into, the shape of the external of the multi-joint structure was tubular or cylindrical shape.

The multi-joint structure of claim 3 of the present invention is characterized in that, comprises the circuit pattern of the power line and the signal line in a surface or an inside layer in the multi-joint structure of claim 1.

The multi-joint structure of the present invention is miniaturized by excluding wiring in the signal line and the power line, etc., and arranging the pattern in the main body of the multi-joint structure.

For instance, the surface material of the multi-joint structure is assumed to be a plastic resin. Moreover, the substrate pattern of circuit board is drawn on a plastic resin in the layer the surface or in. As a result, the electric circuit substrate and wiring can be lost.

The multi-joint structure of claim 4 of the present invention is characterized in that, the joint unit block consisting of 1 or plural joint units comprise the recognition function of self-ID in the entire system. Therefore, information which part of the multi-joint structure on changed can be uniquely specified in the system where a lot of multi-joint structures exist.

Moreover, the detection of peculiar information or the information transmission from the part corresponding to the joint unit or the joint unit brock in the object body that is necessary is enabled. The multi-joint structure can be similarly used for these in the system that scatters by a wireless means etc.

In the multi-joint structure of the present invention, 1 or plural joint units can be separated and be connected in an arbitrary connected part. The means of the separation and connection includes an automatic separation and connected means to combine the computer, the communication apparatus by the wireless and cable, and the power plant and transmission gears such as motors. Moreover, it is not limited to them. The one comprising the computer and the power plant and transmission gear is included in each joint unit. Moreover, the separation and connection by the manual operation are included.

The entire size can be freely controlled by being able to separate and to connect each joint unit like the block. Moreover, the application range is extensible by providing various functions for the joint unit as described as follows.

Moreover, the multi-joint structure of the present invention comprises the automatic recognition function of self-ID such as ad hoc. As a result, the joint unit group etc. composed of a multi-joint structure or a wireless means can be immediately specified in the system every time the joint unit or the joint unit block is connected and separated by cable and a wireless means. As a result, which part of which multi-joint structure whether newly establish or updated in the system where plural multi joint structures exist can be specified uniquely and immediately. This information in real time enables peculiar information detection from the correspondence part of a new object and the information transmission to the part by the automatic recognition function of self-ID.

The multi-joint structure of the present invention comprises the power means that connected part between joint units can be moved, and enables the transformation of whole of multi-joint structure shape and the movement by bending and stretching.

Whole of multi-joint structure shape can be controlled by installing the power means that connected part between joint units can be moved. Each joint unit of the multi-joint structure can be connected and be separated autonomous by making the connected part movable with the motor etc. As a result, connected part can do various movement of the back and forth, right and left, and the rotation, etc.

The joint unit can comprise driving means, and the multi-joint structure of the present invention be moved by 1 or plural joint unit or whole multi-joint structures.

Since the joint unit comprises driving means, it can move in the entire multi-joint structure as one body. At the same time, it can move originally in the joint unit independently of the multi-joint structure. Here, driving means of the joint unit is suitably transportation of the crawler type. The multi-joint structure can enter the inside by the space with a narrow building that collapses in a time of disaster passing and coming off if it is assumed the transportation of the crawler type.

Moreover, the multi-joint structure becomes possible by assuming the transportation of the crawler type the prompt movement of the stairs as well as the two-legged robot. First of all, the joint that moves in the struck building should go into in the struck building. The joint unit is compacter than the humanoid robot of two walking. The joint unit becomes tube shape that goes into in the struck building it easily by connecting the length scales.

As described later, the joint unit connects the length scales because ascending and descending the stairs and opening and shutting that uses the knob of the door can be done as well as the humanoid robot. The joint unit comprising the crawler type drive means becomes a simple composition, and can be moved promptly.

The multi-joint structure of the present invention comprises the means of communication and the sensor means in the joint unit further. As a result, plural joint units can separate and connect through connected part, and connected part drive a multi axis.

Here, the joint unit communicates mutually, and sends and receives the signal between relay bureau units described later as for the means of communication. When the joint unit connects it, the cable communication and the wireless is communicated. Moreover, the wireless is communicated when the joint unit is separate.

Moreover, the sensor means is, for instance, a heat ray sensor to detect human body etc. (infrared sensor), a solid detection sensor, a temperature sensor to investigate environment, a gas sensor, a camera sensor to take picture of site image, and a razascaning device and sonar for obstacle detection.

Moreover, the sensor means contains a vital sensor that detects person's heart sound to search for the victim.

Besides this, the voice I/O means and the electric power sending and receiving means such as mikes and speakers are comprised. It is also possible to contain other components.

It is said as connection and separation through connected part of plural joint units to connect and to separate by each joint unit's using connected part like the train according to the situation described as follows.

For instance, when the multi-joint structure enters in the building such as ascending and descending of the stairs, getting over of obstacle, opening of gateway door, solving the problem like the difference of the stars and the height of the knob of the door becomes possible by each joint unit's connecting the length scales and moving like the tube.

When there is a difference of the stairs, each joint unit is connected, becomes a tube structure, and moves. Driving power of the joint unit located in the horizontal part joins driving power of the joint unit that tires to exceed the difference though connected part, and the multi-joint structure gets over the difference of the stairs. Moreover, connected the joint units move like the tube toward the knob of the door, and it crawls up to the position of the knob of the door. The first joint unit that has the hand means operates the knob of the door and the door is opened. These are described in detail by the embodiment described later.

Moreover, when searching for the wide rage together, the joint unit of each connected part is separated. Each joint unit moves independently, and the victim's search and the state of the site are observed and investigated.

Connected part comprises the function to dive a multi axis. The joint unit can be freely operated by connected part with the top and bottom, the right and left, and the rotation.

The multi-joint structure of the present invention comprises at least one relay bureau unit that comprises the part GPS for positional recognition and radio communication part in the joint unit. And, the position where the relay bureau unit is arranged is specific by using a prescribed algorithm. Moreover, it moves to the arrangement position by using driving means and the means of communication. The relay bureau unit is exhausted from the inside of the joint unit and arranged.

An internal reinforced concrete etc. become the electric wave troubles when the building collapses, and the electric wave doesn't arrive from the outside to the inside of the building. Plural joint units of the multi-joint structure of the present invention connect the length scales, it enters like the tube in the building, and each joint unit is separated in the building, and it moves independently and it searches. However, it is expected for the building inner wall side and the collapse building to become a trouble in this case, and to enter a state that each joint unit cannot be communicated and a difficult state to recognize the position.

Then, the technology that identifies the position of the object in the building is used by arranging three transmitters or more of GPS in the room where the electric wave doesn't reach. The relay bureau unit comprising the GPS part and radio communication part are installed in the joint unit specifically. The joint unit arranges the relay bureau unit arbitrarily in the building to lay eggs. As a result, each joint unit can recognize an own position.

A prescribed algorithm is used to specify the position where the relay bureau unit is arranged. The purpose of this reason is to put a prescribed spatial interval so as not to arrange the relay bureau unit in the neighborhood area more than once and to arrange the relay bureau unit.

The above-mentioned algorithm judges the position where the relay bureau unit is arranged the boundary point in the reception area of the GPS communication from three relay bureau unit and joint units.

When progressing to the point where the reception from the relay bureau unit equipped with three parts GPS becomes improper, each joint unit does the following for the continuance of the identification function of the position. Each joint unit arranges one relay bureau unit further. Or, the joint unit itself functions as GPS transmitter. As a result, the continuance of the identification function of the position of each joint unit becomes possible.

The multi-joint structure of the present invention identifies the position of the joint unit from whole of multi-joint structure shape and GPS for positional recognition.

The multi-joint structure of the present invention is characterized in having been assumed the composition that unites so that the robot comprising the hand means that the doorknob can be operated to open and shut a door is arranged at the head.

The method of operating the reduced doorknob and the turning doorknob is described. First of all, each joint unit unites so that the joint unit comprising the hand means may connect it with the head. Each joint unit connects, it moves like the tube, and it crawls up to the position of the knob of the door. The first robot comprising the hand means operates the knob of the door and the door is opened.

Here, the doorknob is placed from the right and left with the hand means. Moreover, shape, the size, and the position of the doorknob are recognized by the sensor means comprised in the joint unit of the multi-joint structure.

The sensor that does the distance measurement to subject and taking a picture of the image of subject at the same tire is installed in the multi-joint structure of the present invention.

The sensor that may do the distance measurement to subject and taking a picture of the image of subject at the same time is, for instance, two camera sensors that arrange the stereo, three optical cutting method dimension sensor, and image sensor using MOS (complementary metallic oxide semiconductor).

Distance image CMOS image sensor is used from the viewpoint of the response speed and the power saving for the joint unit of the multi-joint structure. As a result, the person position detection, the obstacle detection, and the doorknob position detection are enabled.

The multi-joint structure of claim 5 of the present invention is characterized in that, the joint unit comprises Light Emitting Diode, and operation and the state of the sensor can be observed from the outside.

The purpose is to be able to confirm operation and the state of the sensor of each joint unit of the multi-joint structure by eyes. For instance, when the arm of the person who installed FST is extended, a LED does the flash in the extended direction. A LED lights red when moving up. A LED lights blue when moving below. As a result, it can inform surroundings of the movement of the human body that installed FST under the environment of the dark.

The multi-joint structure of claim 6 of the present invention is characterized in that, the joint unit comprises the rotation mechanism. The mechanism where the joint unit rotates on the axis is called a rotation mechanism here.

The degree of freedom of the transformation of whole shape improves since each joint unit comprises the rotation mechanism. Stability keeps whole of multi-joint structure posture preventing the twist with the rotation mechanism when the ranging joint unit is in the environment such as up hills.

Moreover, the earth power is improved by rotating only a part of joint unit by controlling the rotation mechanism responding to the inclination environment.

A mounting tool of claim 7 of the present invention is characterized in incorporating the multi-joint structure according to claim 1.

A mounting tool here contains general clothes like jacket, special clothes like asbestos clothing, body briefer for in stance. The multi-joint structure is built into these clothes. How to build in the multi-joint structure is described by the following embodiments.

A mounting tool of claim 8 of the present invention is characterized in that, filter processing to nullify minute change of human body at the time of equipping a human body with the mounting tool according to claim 7 is comprised in operation processing part.

A minute change when mounting it in the human body is nullified like the blurring prevention camera.

A mounting tool of claim 9 of the present invention is characterized in that, the multi-joint structure according to claim 1 in both hands, both legs, and the head respectively can measure in real time each position and each operation of both hands, both legs, and the head, from a position of standard device attached to the waist or the back and from whole shape of multi-joint structure.

A mounting tool of claim 10 of the present invention is characterized in that, the multi-joint structure according to claim 1 in arm, and in real time measures moving operation of arm from a position of standard device attached to movable body including at least wheelchair and whole shape of multi-joint structure, and is able to control movable body.

A mounting tool of claim 11 of the present invention is characterized in that, the multi-joint structure according to claim 4, in both hands, both legs, and the head respectively, measure in real time each position and each operation of both hands, both legs, and the head, from a position of standard device attached to the waist or the back and from whole shape of multi-joint structure, and use the measurement data as data for rehabilitation or data for training, and can move connected part of the above-mentioned multi-joint structure according to the difference with the target value data.

A mounting tool of claim 12 of the present invention is characterized in that, a finger is equipped with the multi-joint structure of claim 1 and each inputs, such as keyboard input, can carry out.

A mounting tool of claim 13 of the present invention is characterized in being equipping an arm and a finger with the multi-joint structure according to claim 1, and being able to perform technique of an operation by remoteness.

A medical device of claim 14 of the present invention is characterized in being equipping a medical device used for technique of an endoscope with the multi-joint structure according to claim 1, and performing position recognition of medical device.

Patient's pain is reduced by identifying the positions of endoscopes such as stomachs and large intestines. Moreover, it can go into the inside of the blood vessel and the urinary duct by minutely composing the multi-joint structure.

Planar structure of claim 15 of the present invention is characterized in that, plural multi-joint structures according to claim are arranged and the planar structure is composed.

Solid structure of claim 16 of the present invention is characterized in making a flat surface of planar structure crooked, and being able to form a solid when a connecting part of multi-joint structure which constitutes the planar structure according to claim 15 moves by power means.

The system of claim 17 of the present invention is characterized in being connected with the controller of the shipboard by the multi-joint structure according to claim 1, has the transportation such as propellers that surface, subside in water, or move front, back, left and right, the system can control for target position moving movable body by in real time identifying position and operation of movable body, and can do data communication and power supply to movable body.

The system of claim 18 of the present invention is characterized in that, investigation of a ship's bottom without raising movable body to dock of ship or basic assembly work in the bottom of water can be done, movable body comprises at least camera, sensor, and arm.

Human machine interface of claim 19 of the present invention is characterized in that, the above-mentioned movable body may be operated with the mounting tool incorporating the multi-joint structure according to claim 1, in each part of a human body containing both hands, both legs, the head, and a finger respectively, can measure in real time each position and each operation of each part of a human body, from a position of standard device attached to containing the waist, the back, or a robot and from whole shape of multi-joint structure.

The multi-joint structure of claim 20 of the present invention is characterized in that, the joint unit is covered with the hull corresponding to the necessity like the waterproof, dustproof, and fire prevention, and it was added at the same time by the means to fix the hull.

### Effects of the Invention

The multi-joint structure of the present invention has the following effects. The multi-joint structure automatically or manually enables the separation and the connection of every 1 piece or several. The multi-joint structure can be connected with the multistep by using one connected divergence means or more. As a result, positional identification by the cooperation of a cable technology and a wireless technology and the automatic authentication of self-ID become possible.

Moreover, the multi-joint structure of the present invention can be used by being installed in the human body as a sensor that detects the movement of the human body and fingers. For instance, the mounting tool using the multi-joint structure of the present invention can be used for training device for rehabilitation, training device for sports, and skill person's legend assistance devices.

Moreover, it could work easily by using the multi-joint structure of the present invention under understanding of the position of an underwater so on a difficult, very bad environment.

In addition, plural joint units can move promptly while searching for the victim in the building of the stairs and doors in the subway station, the underground shopping center, and the airport and the skyscraper, etc., and collect sensor information on image information etc. to the decided point and the route based on the GIS map in the building high-speed and distributing it.

### BRIEF DESCRIPTION OF THE DRAWINGS

FIG. 1 is the outline shape perspective view of flexible sensor tube (FST) of the present invention

FIG. 2 is the appearance perspective view of two FST of the present invention to combine intuition.

FIG. 3 is the outline view where intuition was combined with diverging uniting unit

FIG. 4 is the illustration where FST is installed in person's hand, foot, and head

FIG. 5 is the image view built into clothes

FIG. 6 is the outline view of FST that can be divided every one piece

FIG. 7 is the outline view of the crawler of accompanied FST

FIG. 8 is the image view Image chart of rescue site

FIG. 9 is the image view of cooperation of wireless and cable

FIG. 10 is the image view of cooperation in water

FIG. 11 is the image view Image chart of cooperation with getting on and off type robot

FIG. 12 is the image view of finger FST (gloves)

FIG. 13 is the image view of application to endoscope

FIG. 14 is the image view that composes chair of FST

FIG. 15 is the outline composition chart of FST

FIG. 16 is the appearance image view where FST connected length scales

FIG. 17 is the image view that each joint unit originally moves and searches for

FIG. 18 is the image view where FST searches in building of the third floor in underground

FIG. 19 is the image view that each joint unit of FST is exhausted relay bureau unit for GPS communication and arranged

FIG. 20 is the image view to which each joint unit of FST connects length scales and it began to go up the stairs by one step

FIG. 21 is the image view to which each joint unit of FST connects length scales and it went up the stairs by three steps

FIG. 22 is the image view where each joint unit of FST connects and it crawls up to position of knob of door

FIG. 23 is the image view where FST places doorknob from the right and left

### BEST MODE FOR CARRYING OUT THE INVENTION

Hereafter, the embodiment of the present invention is described in detail in reference to figure. However, the scope of the invention is not limited to the example of shown in the figure.

### Embodiment 1

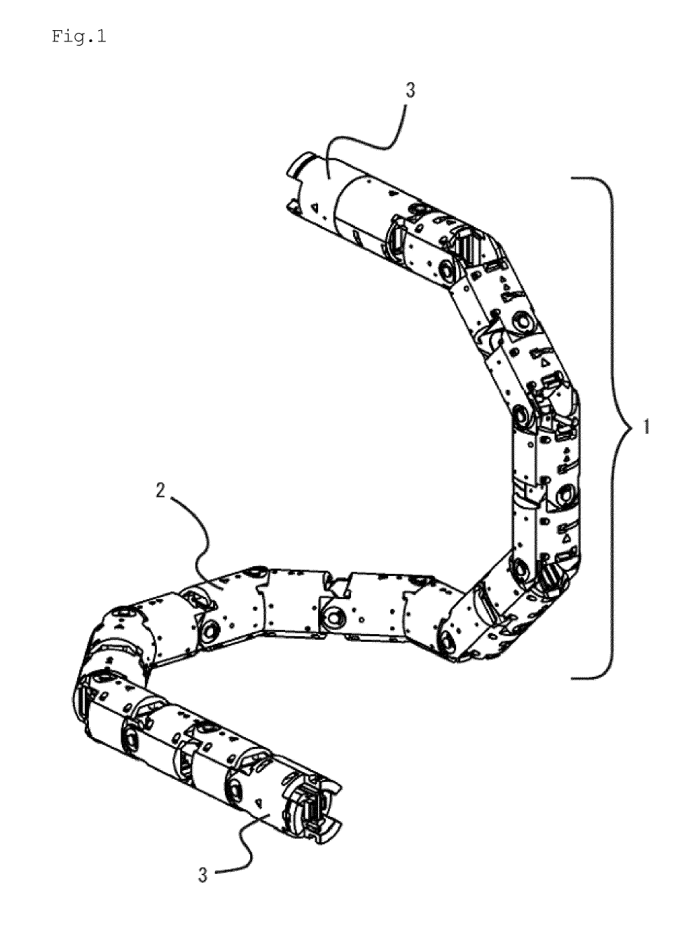

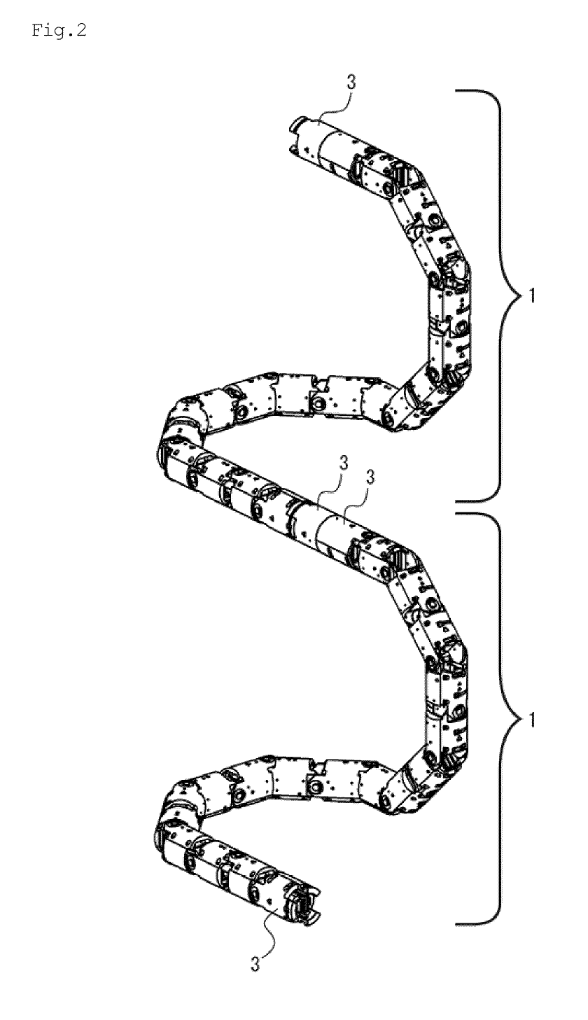

FIG. 1 is whole of multi-joint structure (Hereafter, it is called FST) according to the present invention perspective view. FIG. 2 is perspective view in the state that two FST combined intuition. FST 1 assumes joint unit 2 to be a minimum unit, and is a structure of the tube shape composed of plural joint units. Movable between each joint units in free. Each FST connects the joint unit at both ends with other FST as connected joint unit 3. As a result, the multi-joint structure to which a lot of joint units range can be composed. As for the moving part of each joint unit, the potentiometer of the change of the change of the opposing angle of the joint unit, the change of the distance, and the axis rotation (Twist) for the change amount detection has been installed. CPU board is set in ten joint units at one rate. Moreover, the arithmetic unit of processing of one FST as a whole has been installed. The electric wire has been installed in the structure of the tube shape.

CPU board assumes ten joint units to be one unit, and processes the variation data that the potentiometer detected.

The data that CPU board processed is transmitted in real time to the processing operation part by using the cable communication network in the structure of the tube shape and processed. The change data between processed joint units is output as an amount of the movement and a vector.

The structure shown in FIG. 1 and FIG. 2 is tube shape. The detection data communication network is composed of the cable wired for in the tube. However, the multi-joint structure of the present invention is not limited to the tube shape. For instance, a rodlike structure or line structure can be applied.

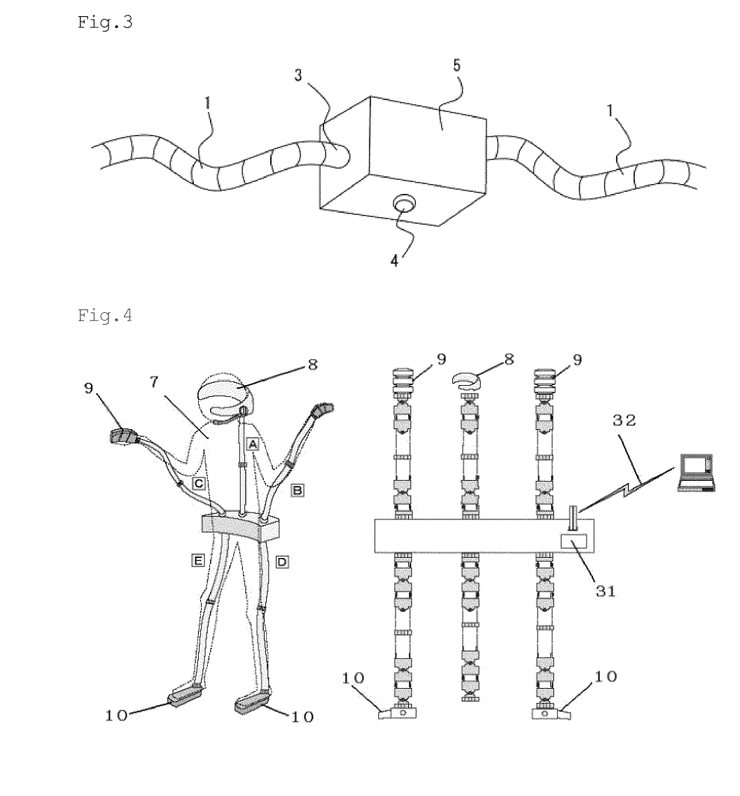

FIG. 3 is perspective view in the state to combine intuition with connected unit that diverges FST. Joint unit 3 (connected joint unit) on the edge of FST is inserted in joint 4 with FST installed in relay and divergence box 5. And, the other plural FST and intuition can combine at a time by the uniting unit.

FIG. 6(A) is perspective view of a joint unit minimum. Each joint unit of FST comprises joint 13 connected with other joint units at the both ends. On joint 13 at both ends, the other joint presents small ring shape to round from the main body of the joint unit (ring). The other joint presents the cutting lack ring shape to have the cutting lack part in three places in the same to main body diameter (cutting lack ring). The size of the ring can engage with the cutting lack ring. Each joint units could be separated and be united easily by using the power such as motors.

FIG. 6(B) is perspective view in the state that three joint units unite. Ring A engages with cutting lack ring B, and three joint units are connected. The rotation angle between joint units changes when ring A rotates according to the inner in cutting lack ring B by a small motor (Not shown). The rotation mechanism is not especially shown in the figure. The rotation mechanism uses the mechanism that rotates within the range of ±90° like the focusing ring of the camera lens for instance.

Moreover, the ring and the cutting lack ring are connected with a flexible fitting (Not shown), and the motor and the controller are comprised. As a result, about the interval between joint units can be expanded and contracted, and the position be changed up and down and right and left. Even if the ring and the cutting lack ring are assumed to be a fold flexible structure, and the motor and the controller are comprised, a similar effect can be achieved.

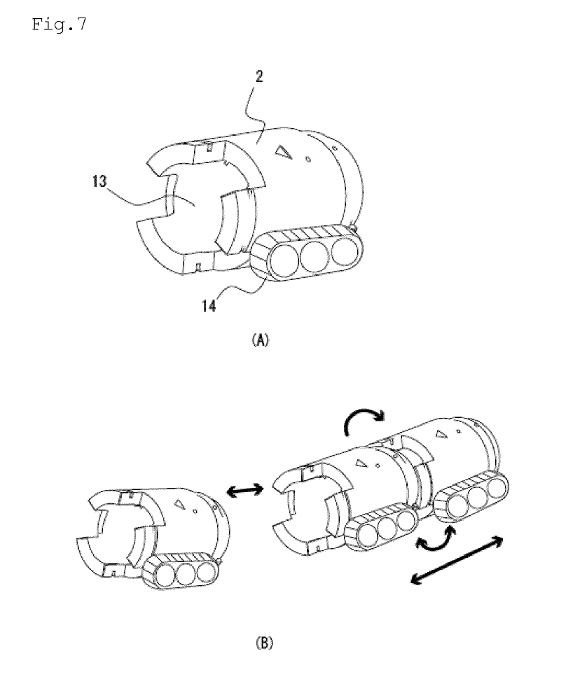

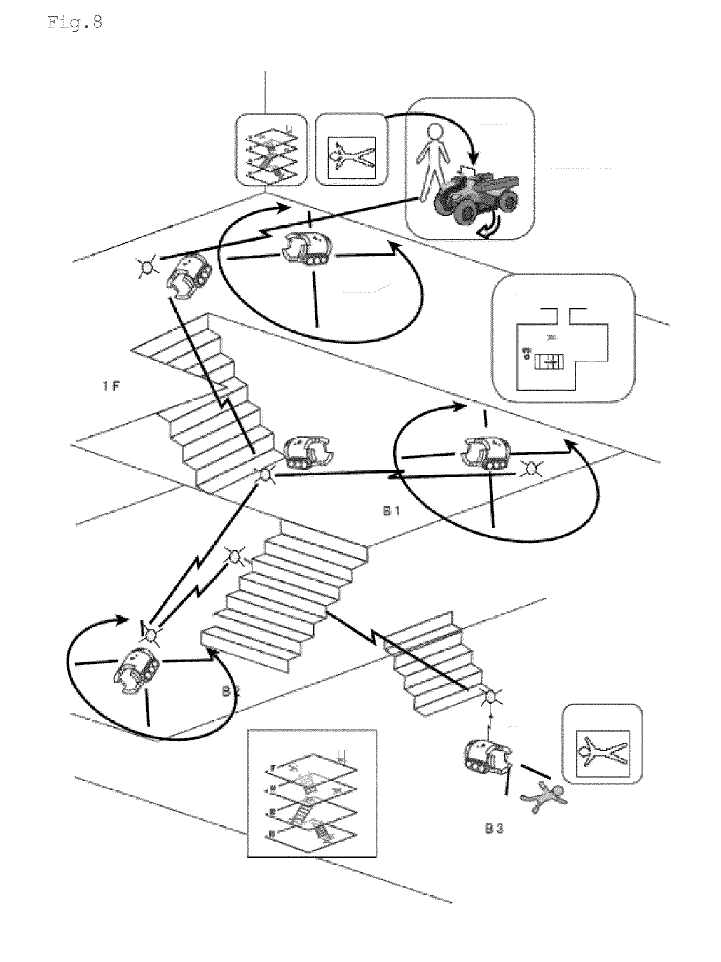

FIG. 7(A) shows the state to install crawler 14 in the joint unit. FIG. 7(B) separates each joint unit, and shows the appearance that moves with each joint unit. Since it progresses on the ruggedness and the plane with the difference and hollows, the transportation of the crawler type is suitable for driving means. As for driving means, other progress means are used.

In FIG. 7, the crawler has been installed under both sides of the joint unit. However, it is not limited to this type. For instance, the crawler is installed in the upper part of the joint unit by the addition. It is assumed that the joint unit dropped to the hollow. The crawler under both sides of the joint unit runs idle. In this case, an upper crawler helps the movement of the joint unit.

FIG. 4 is an image chart in the state to install FST in the human body. Head mounted display (HMD) connected with FST is installed in the head. Four FST is installed in the both arms and both legs. The hand controller is set up in the both hands part, and the foot controller is set up in both feet part. In addition, the standard part (divergence unit) connected with five FST is set up in the waist. The position of the head, both hands, both feet, both arms, and both legs and shape are in real time collected by FST by centering on the standard part. The collected data can be transmitted outside as the remote place etc. according to a cable communication or a wireless communication.

So-called “Master-slave operation” that controls an outside robot and the machine based on the information can be achieved. In addition, the image data obtained with HMD, hand controller's data, and foot controller's data can be output by the communication. Moreover, if driving part is added to FST, the operation of both hands and both feet of the human body can be appropriately amended. That is, it can control to the human body through FST. The controller installed in both hands and both feet can support the human operation.

For instance, the human body can be moved by a speed or usual slow motion to do an ideal golf swing only by installing FST. Thus, various applications are considered.

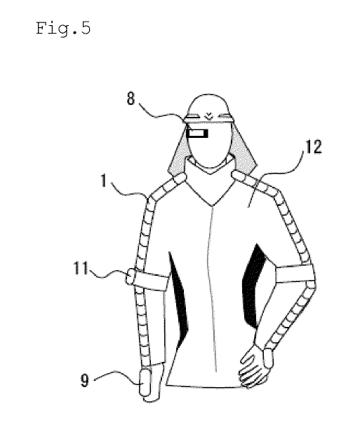

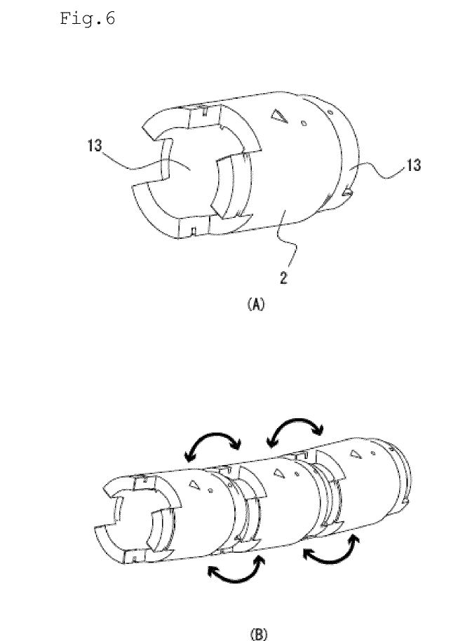

FIG. 5 is an image chart in the state to build FST into the asbestos clothing. Clothes 12 that build in FST are composed of FST 1, head mounted display (HMD) 8, hand controller 9, and grip 11 of the elbow.

In the disaster scene of the dark, the fireman can control the rescue robot etc. operated remotely by master-slave by wearing clothes that build in FST. It describes by the concrete example. The fireman who installed FST is assumed to be a master, the extinction robot is assumed to be a slave, and the extinction robot approach (the site of the high temperature that the person cannot approach. The master can see how matters standby projecting the camera image equipped with the image from the site in the extinction robot onto HMD.

Next, when the arm that installed FST is move, FST detects the change in the position and the movement of the self. The extinction robot can be controlled by those information. The movement of advancement etc. and the control of an arm for extinguishing fires such as draining water off can be done only by operating the arm based on information on HMD.

Moreover, the image information in the dark can be acquired by giving HMD the means to have the shade visual performance such as infrared cameras.

Moreover, it is also possible to add the sensor that receives information from the human body and the surrounding as FST or a peripheral composition parts. The sensor group that can recognize living body information such as the muscular telegraphic signal and the pulse, environmental information such as the terrestrial magnetism and the atmospheric pressure, and dangerous information such as radio activities and the noxious fumes respectively is installed in FST. As a result, the uniform management of the information can be done with HMD 8.

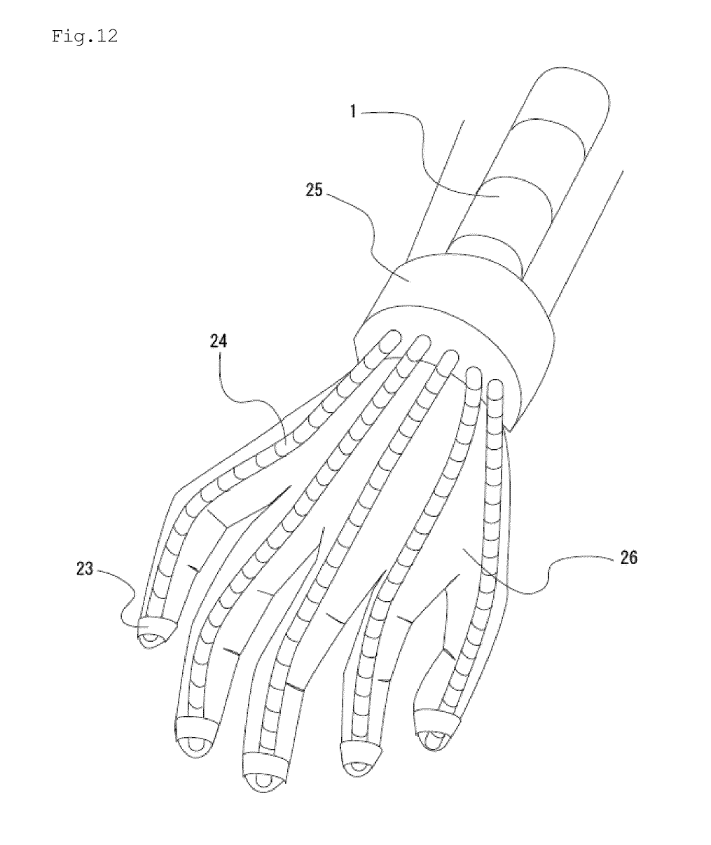

FIG. 12 is an image chart where FST was installed in the hand and the finger. Glove 26 is composed of finger pressure sensor 23, FST 24 for the finger of a minute diameter, and divergence unit 25. Divergence unit 25 connects FST 1 with FST 24. The movement of installation person's the tip of a finger is made data through FST and finger pressure sensor 23. The data can be accumulated and be output. Moreover, information made data can be reproduced accurately through FST and finger pressure sensor 23. It remote diagnoses and it can treat remotely by adding the radio communication equipment to glove 26.

The pulse is measured with finger pressure sensor 23, and the state is understood. It combines with the image information such as TV cameras, and treatment and a minute operation can be performed. Coordinated play that the emergency allowance is done with this device, and the doctor operates later becomes possible in the doctorless village region such as leaving the island.

In addition, this device is installed in performance person's hand and finger. The movement of performance person's hand and finger is made data. And, information made data is reproduced with this device.

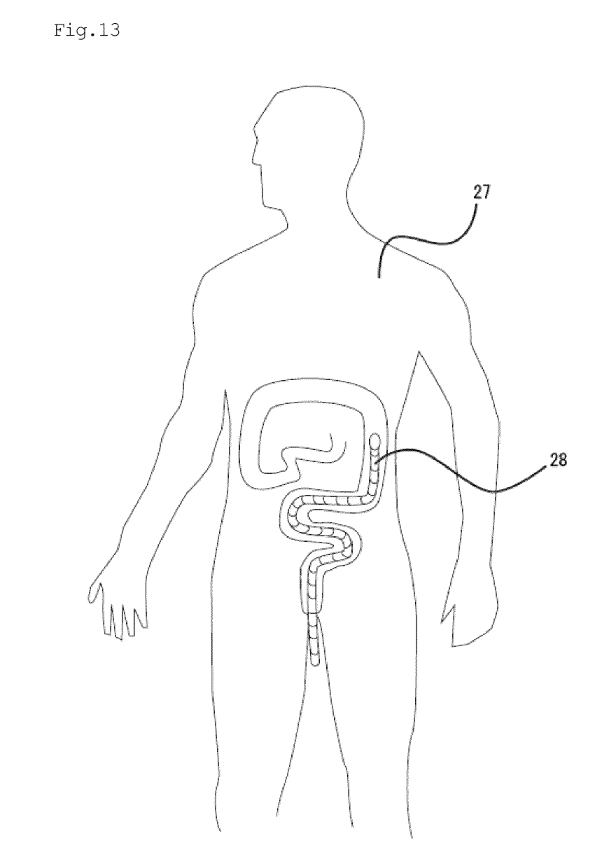

FIG. 13 is an image chart of the device that combines FST with the endoscope. 27 is a human body, and 28 is an endoscope. The position and the direction of the endoscope are understood by FST accurately. Therefore, the position such as tumors can be understood accurately.

Moreover, the movement of the endoscope can be exactly controlled through FST. Therefore, the check leakage that may be caused when the person operates it can be lost, and an internal state such as the enteric canals be checked completely.

Moreover, FET can be used for the following usages by minutely composing. FST goes into in the blood vessel, takes a picture of the image, and removes the obstacle with the vessel wall with the possibility of causing arteriosclerosis. Moreover, FST passes, takes a picture of the image, and destroys the stone from the urethra with the bladder, the urinary duct, and the kidney. Since the position and the shape of the tube where they are made to go into it can be identified, and the actuator means to move the edge or the whole to the front, back, left and right (The tube is transformed) is mounted, it becomes practical use for the first time. For instance, it was extremely difficult in the prior art to put the tube that had entered the bladder in the urinary duct further after they had been made to go into it from the urethra such as penises. Moving the point to the going into it entrance confirming the image and information on the FST shape by using FET becomes possible.

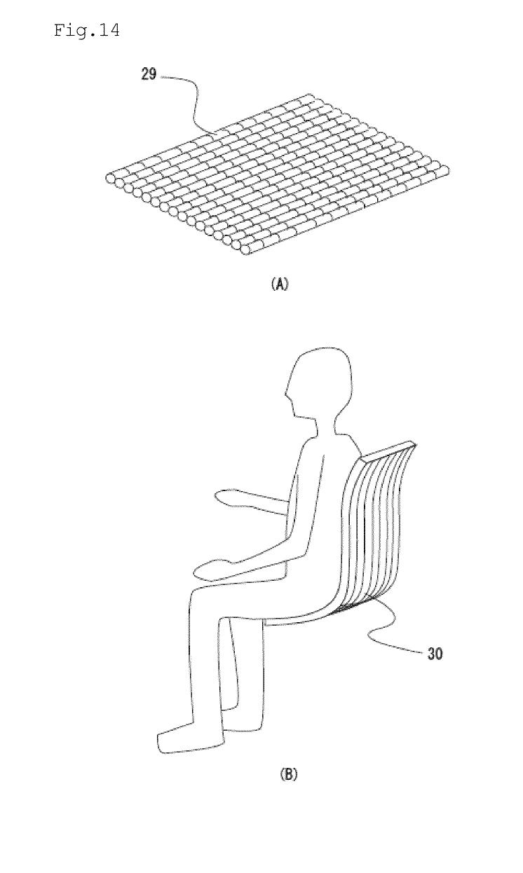

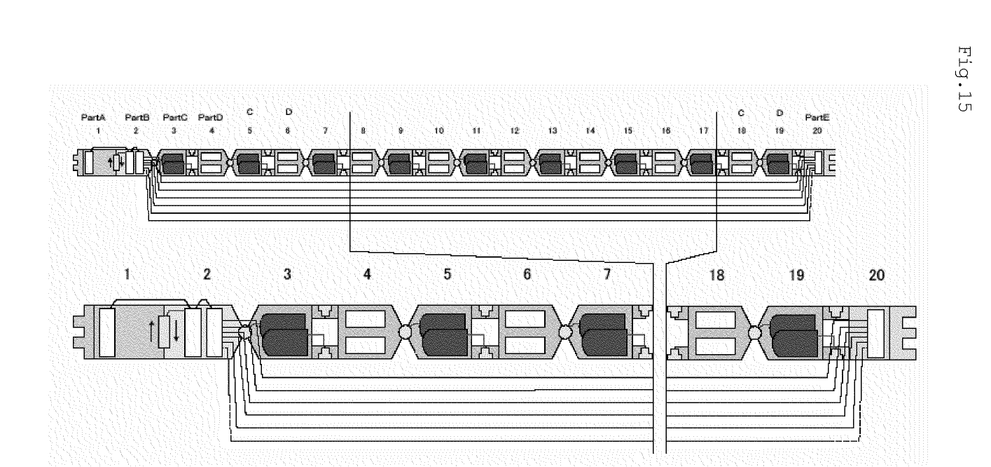

FIG. 14(A) is a planar structural image chart where FST was sideways displayed. 29 shows planar structural FST. FIG. 14(B) is an image chart though also starts up a part of planar structural FST and formed the drip also by the seat of a chair and the back. 30 shows the mounting state recognition sensor. FST can produce various shape by assuming a planar structure. It is also possible to change into appropriate shape corresponding to the situation, and to change into the further shape in a time of disaster by the change of the situation. It describes by the example. Laid patient causes the pressure sore. Moreover, the patient in the state of sitting or the wheelchair causes the pressure sore. Respect of the bed and the chair is composed of planar structural FST. And, FST is transformed at any time based on information such as weighted that hang to planar structural FST. As a result, the place where the load hangs is moved, and relieving suffering becomes possible.

In this case, combining with means of the air pressure and the oil pressure, etc. as power for the transformation is also effective.

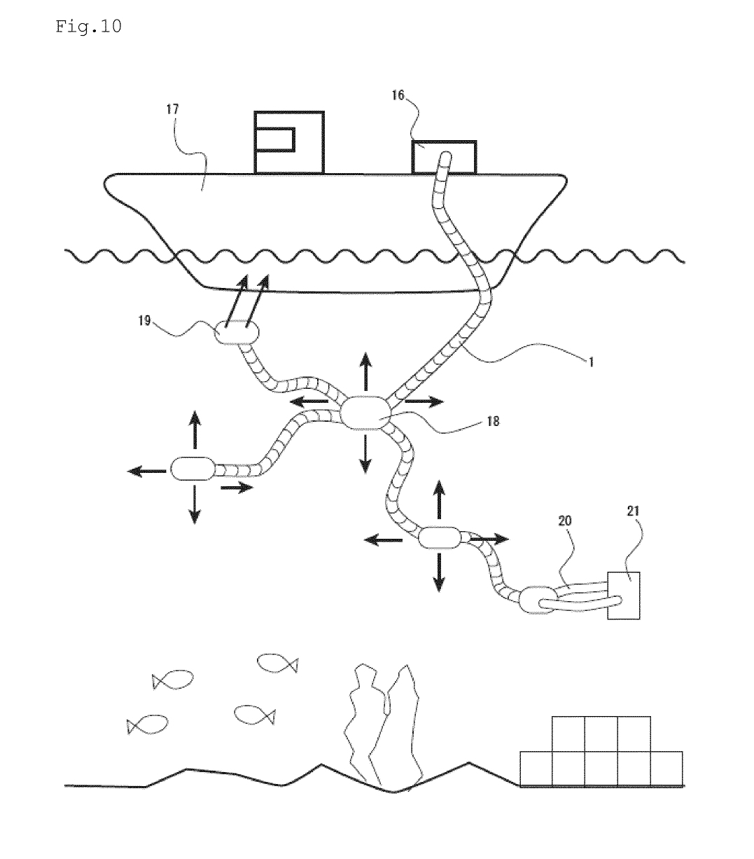

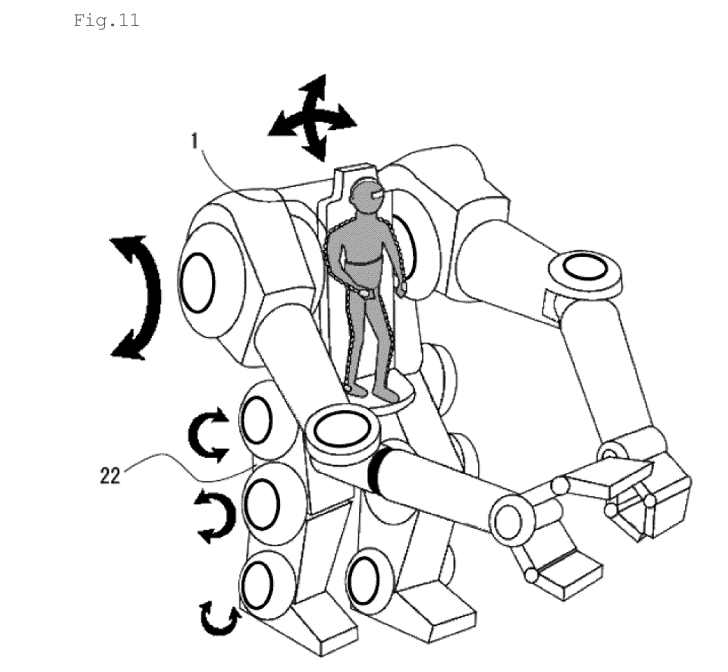

FIG. 10 is an image chart of the system that works for water by using FST. This system is composed of FST 1, FST connection reference point 16 of shipboard, underwater movement unit 18 with movement power, surveillance camera 19, underwater hand 20.

In the underwater work including the watch, an accurate grasp of the position is difficult. A difficult reason is that it is dark since light doesn't reach the underwater work easily. It is moreover because the influence of the current is received easily. Moreover, a prompt control of the position is difficult. However, the grasp of the position and the control could be easily done by using FST. FST diverges with the underwater movement unit. As a result, quick movement can be done.

Moreover, it can correspond to plural objects at the same time. As for underwater movement unit 18, the camera and the sensor are installed. As a result, the situation in water can be monitored. As for FST 1 of underwater movement unit 18, underwater hand 20 is installed. The position of underwater hand 20 is understood accurately by the positional identification function of FST based on FST connection reference point 16. As a result, it could easily reach moving object body 21. It can get to the moving destination accurately and promptly by the positional identification function of FST after moving object body 21 is held.

Since the surveillance camera is set up in FST, the bottom of a ship situation of wound and shellfish's adhesions etc. can be all over checked. Accuracy and the position can be identified because of a standard position even if thrown into the current. Therefore, the surveillance camera can be returned to a correct position by a positional control. Therefore, the state that should be checked is not missed.

FIG. 11 is an image chart of the system that makes FST cooperate with getting on and off type robot 22. As for the getting on and off type robot, the shouter, the elbow, the hand, the waist, the knee, and the ankle are being designed by movable. FST is installed in operator's shoulder, both hands, both arms, both legs, and both feet corresponding to a movable part of the robot for getting on and off. When operator moves the shoulder and the arm, the operation is made data by FST. And, data is transmitted as an operation instruction to the correspondence part of the getting on and off type robot. The robot operates a movable part according to the instruction. Therefore, the robot does the same movement as operator. Thus, the robot for getting on and off can be manipulated by combining FST and the robot like operator's mind.

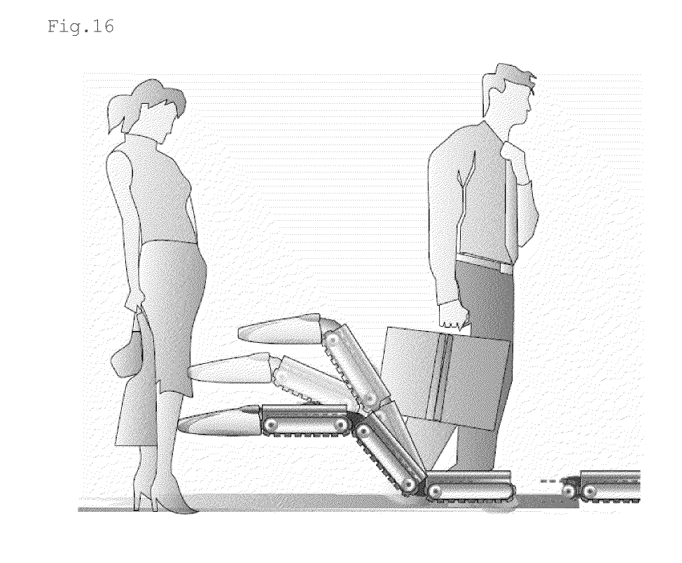

FIG. 15 shows the outline composition chart of FST of the present invention. Each joint unit of FET comprises driving means of the crawler type and the wireless communication means. Moreover, the camera sensor and the heat ray sensor are comprised as a sensor means. Each joint unit can be connected and be separated mutually freely through connected part. It might be necessary to enter in the building such as ascending and descending of the stairs, getting over of obstacle, opening of gateway door. In that case, FET is connected each joint units in the length scales and moves like the tube. Each joint unit separates from the main body of FET when a wide-ranging search is done after FET goes into the building, and each joint unit originally moves and searches.

In this case, it is also possible to divide, to move, and to search as a single joint unit. Moreover, it is also possible to move and to search as the tint unit connects 2 pieces or 3 pieces. A part of joint might function as a special module though all of each joint unit might comprise the same function. A special module is, for instance, the robot that assumes rescue goods (food and water) transportation to be main function, the robot with hand means, and the robot for battery replenishment etc. Both functions as the joint unit of the multi-joint structure are possessed.

Moreover, connected part of each joint unit comprises the function to drive a multi axis. Connected part can drive a multi axis in the top and bottom, the right and left, and the direction of the rotation since each joint unit connects the length scales and FET can move like the snake.

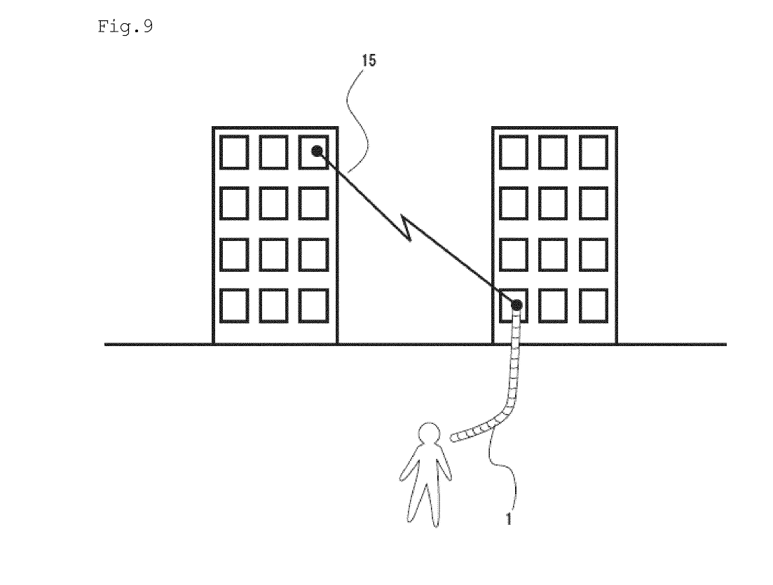

FIG. 9 is an image chart where FST is controlled by the cooperation of the wireless and cable. When the whole of FST connects, the cable communication is possible, and the position can be identified. When FST is separated, the wireless communication is possible, and the position can be identified. In connection, the role as the supplementation device of cable can be played.

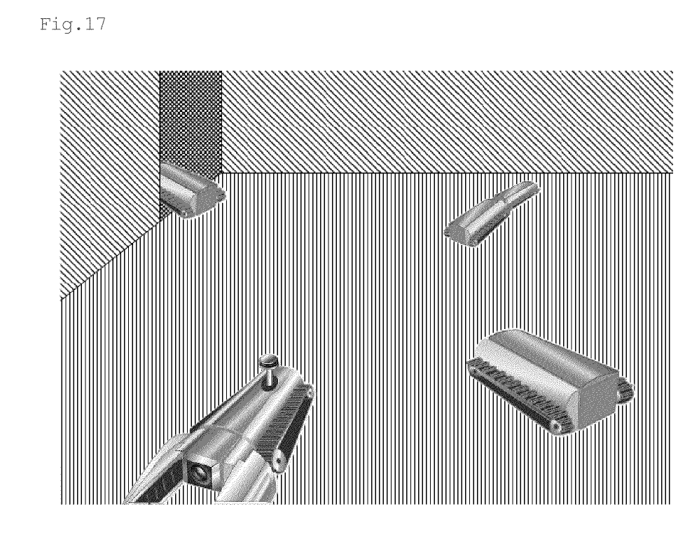

FIG. 16 shows the appearance image chart where the multi-joint structure of the present invention connected the length scales. The joint unit that has the hand means is connected with the head of the length scale connection. Moreover, the joint unit that has the camera sensor is connected secondarily. Driving means of the crawler type has been installed in each joint unit since the second.

FIG. 17 is an image chart that each joint unit originally is separated after the joint unit that connects the length scales invades in the building, and moves and searches for. Each joint unit communicates by the means of communication mutually and collects search information.

The three-dimensional map in the building is made by the process of this information gathering. Therefore, the position of each joint unit should be understood accurately. The relay bureau unit for room GPS construction is arranged in the building so that each joint unit that moves originally may recognize each position. The joint unit is arranged in the building to lay the relay bureau unit for GPS communication comprising the GPS part including antenna for measurement and the wireless network part.

The example is given and it describes specifically. When advancing to a very limit point by which the reception from the relay bureau unit for the GPS communication of three becomes improper, the joint unit is newly laid (one installation). As a reset, the GPS net can be enhanced in an autonomous control. Therefore, the positional identification function of the joint unit can be continued. When the relay bureau unit is arranged, a present position where the joint unit is identified is transmitted to the relay bureau unit. As a result, when withdrawing, the relay bureau unit can be collected.

Moreover, both of plural joint units and plural relay bureau unit for GPS communication are attested and registered on an ad hoc network. An ad hoc network means the network compose of the terminal (personal computer, PDA, and cellular phone, etc.) alone that doesn't need the access point like wireless LAN that can be connected by the wireless here. An ad hoc network is called a decentralized independence wireless network. Each joint unit in real time switches the relay bureau unit for the GPS communication that belongs to an ad hoc network to meshed network composed of the relay bureau unit for the GPS communication that becomes a fixed base with the movement.

Each joint unit identifies the self-position and recognizes the environment on the basis of the location information from the relay bureau unit for the GPS communication. The three-dimensional map is synthesized, made based on the distance data of the solid detection sensor composed of distance image CMOS, and the environment recognition is done. The three-dimensional map is made based on the data that rotates by 360 degrees and is taken a picture of.

However, even if it is the shortest, this method is necessary for the map making for a few seconds. Therefore, the limitation comes out in the movement performance. The taking picture data under the movement is synthesized when the performance that runs down the stairs promptly is demanded, the map is made, and real time is secured.

FET discovers the victim with the heat ray sensor and the camera sensor. And, it talks with the victim by the voice through FET. Moreover, FET transports the rescue supply to the victim.

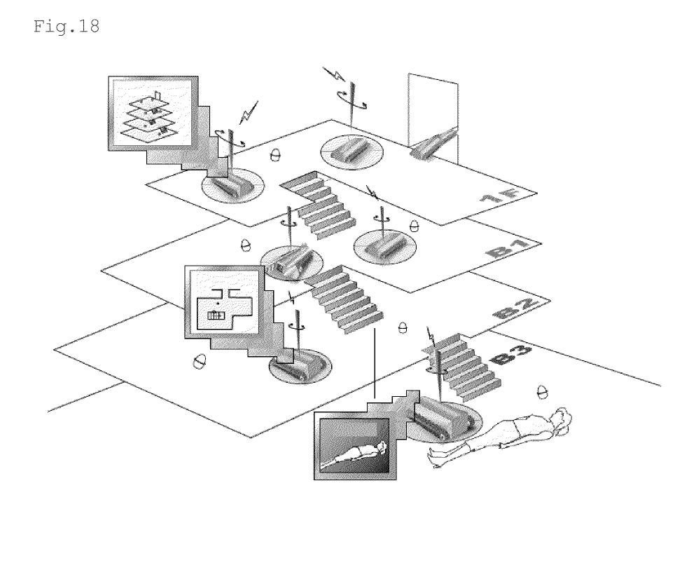

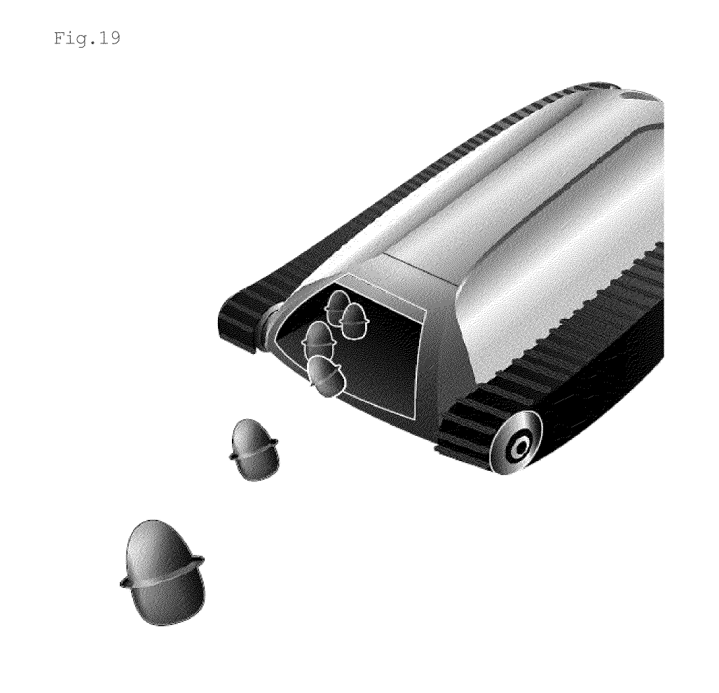

FIG. 18 shows the image chart where the multi-joint structure of the present invention searches in the building of the third floor in the underground. Connected the joint units enter from the doorway of 1F. Two joint units and one relay bureau unit for the GPS communication are set up by the first floor. Two joint units and two relay bureau units for the GPS communication are set up by the B1 floor. One joint unit and two relay bureau units for the GPS communication are set up by the B2 floor. One joint unit and one relay bureau unit for the GPS communication are set up by the B3 floor.

The three-dimensional map in the building is made from collection information from each joint unit, and the mapping is done on the map as for the position of each joint unit.

Moreover, a planar map is made, and the mapping is done on the map as for the position of each joint unit. In figure, the victim is discovered by the B3 floor, and the photographic image is shown. Map information, the location information of each joint unit and relay bureau unit, and to site image information are sent to the joint unit that has entered a building through the wireless. Connected the joint units convey information. And, information is delivered outside of the building. Information is one by one collected. The monitor terminal is set up outside of the building. Operator can understand the struck situation with this monitor terminal.

The person who entered in the communication network constructed with the multi-joint structure of the present invention confirms the image and the location information from each join t unit with HMD connected with the network. At the same time, it is also possible to give the instruction to each joint unit.

Moreover, the movable body comprises the base station function, plural joint units are loaded, and it arrives to the vicinity of the building in which it is struck. The movable body does the first search. The approach where the movable body is the best is secured with struck of a difficult going into (removal of toles and pebbles etc.).

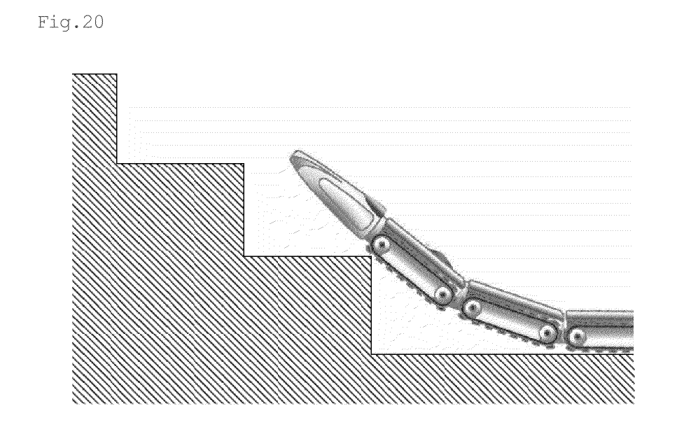

FIG. 19 shows the image chart that each joint unit is exhausted the relay bureau unit for the GPS communication and arranged. Appearance is an airflow egg type as the shape of the relay bureau unit for the GPS communication is exhausted easily from the inside of the joint unit.

It might be necessary to enter in the building such as ascending and descending of the stairs, getting over of obstacle, opening of gateway door. In that case, FET is connected each joint units in the length scales and moves like the tube. When the multi-joint structure of the present invention enters in the building, the solution of the problem like the difference of the stairs and the height of the knob of the door is described.

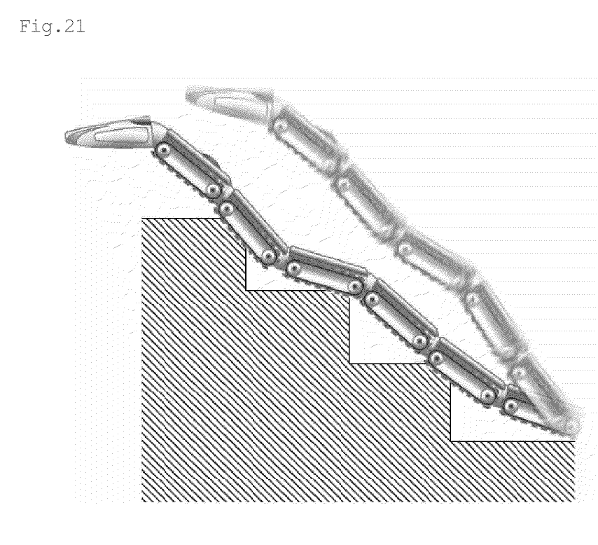

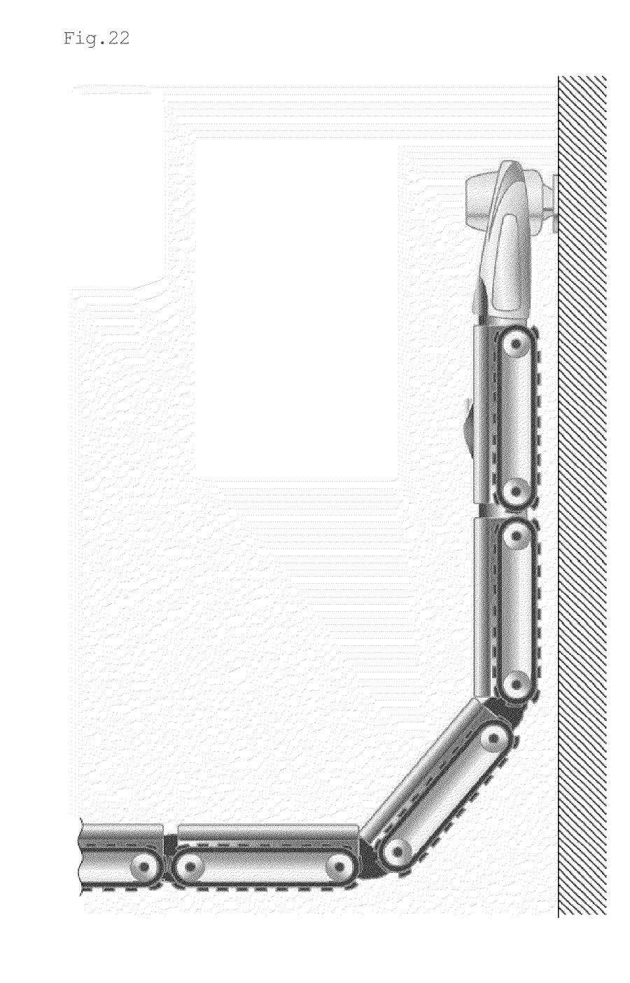

FIG. 20 and FIG. 21 show the image chart to which connected the joint units go up the stairs. FIG. 20 shows the image chart to which the joint unit began to go up the stairs by one step. FIG. 21 shows the image chart to which the joint unit went up the stirs by three steps. It is understood that the crawler type drive means is coordinated with the axis drive means of connected part to get over the difference of the stairs.

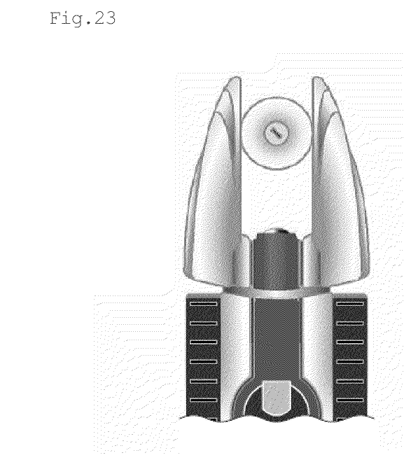

Moreover, FIG. 22 shows the image chart where connected the joint units crawl up to the position of the knob of the door. Connected the joint units move like the tube toward the knob of the door, and it crawls up to the position of the knob of the door. The first joint unit that has the hand means operate the knob of the door and the door is opened.

The hand means can place the turning doorknob from the right and left as shown in FIG. 23. Shape, the size, and the position of the doorknob are recognized by the sensor means. For instance, it is assumed that the door opens when the doorknob is turned clockwise. Connected the joint units turn the doorknob clockwise by transforming whole of the tube shape, and the door is opened.

As described above, the multi-joint structure of the present invention is composed of the joint unit or joint unit block which composed of plural joint units. The entire system should recognize which multi-joint structure in which part exists. For instance, it should be recognized which FST is in the right hand when FET is installed in both hands. This is necessary for both of FST and the entire system. The recognition method can be selected according to each usage. The recognition method is divided roughly into the following three.

(1) It originally makes as an exclusive use of each part (Generality is the lowest).

(2) When connecting it with DIP switch etc., ID is recognized (Generality is a little low).

(3) ID is attested at the same time as connecting it like in-house LAN automatically. For instance, the ad hoc attest (Generality is high)

These will be selected according to the cost and the requested function.

Plural FST connects the multistep or the divergence connection is done. At the same time, the communication network is composed by using a wireless means between plural joint units. The setting is unnecessary, and the extension, the addition, and the breakdown exchange of FST should instantaneously add, delete, and exchange FST under the circumstances. It is the best to select the ad hoc attestation means shown in LAN for the personal computer in such a usage.

Oppositely, when the usage is clear, individual information could be printed out to ROM, and the ID attestation be composed easily.

### INDUSTRIAL APPLICABILITY

The multi-joint structure of the present invention that has been described above becomes possible by having the following features the wide use to various industries. The multi-joint structure automatically or manually enables the separation and the connection of every 1 piece or several. The multi-joint structure can be connected with the multistep by using one connected divergence means or more.

As a result, positional identification by the cooperation of a cable technology and a wireless technology and the automatic authentication of self-ID become possible.

The multi-joint structure of the present invention can be used by installing it in the human body as a sensor that detects the movement of the human body and the finger. Moreover, the mounting tool using the multi-joint structure of the present invention can expect the application of training device for rehabilitation, training device for sports, and skill person's legend assistance devices.

Moreover, the multi-joint structure of the present invention can be used for the robot system for the special environment used when the person buried in toles and pebbles in the building is searched out at the disaster. Plural robots are able to half autonomous run the same average degree of the speed as human walks promptly while excluding evasion of the obstacle, getting over, and a light thing by using the technology in the close spaces such as the subway home (the examination of tickets is included) and underground shopping centers and skyscrapers (the stairs and the door are included).

Moreover, it is understood to monitor the running route of plural robots, and to do to mapping to Geographic Information System as for information on the sensor including plural images. Plural joint units can move promptly while searching for the victim in the building of the stairs and doors and collect sensor information on image information etc. to the decided point and the route based on the GIS map in the building high-speed and distributing it.

### DESCRIPTION OF SYMBOLS

1: Flexible sensor tube (FST)
2: Joint unit minimum
3: Joint
4: FST joint
5: Relay and divergence box
6: Waist installation type divergence box
7: Human body
8: Head mounted display (HMD)
9: Hand controller
10: Foot controller
11: Elbow grip
12: Clothes that built in FST
13: Joint that enables movabilities of the back and forth, right and left, and rotation, etc.
14: Crawler
15: Communication and positional identification means to use wireless
16: FST connection reference point of shipboard
17: Ship
18: Underwater movement unit (connected function having)
19: Surveillance camera
20: Underwater hand
21: Moving object body
22: Robot for getting on and off
23: Finger pressure sensor or motion response
24: FST for finger
25: Divergence unit for FST for finger
26: Gloves that built in FST for finger
27: Human body
28: Endoscope
29: FST that composes of parallel array on plane
30: Mounting state recognition sensor
31: Battery
32: Wireless LAN
A: FST for head (HMD and connection)
B: FST for right hand (It is connected with the hand controller)
C: FST for left hand (It is connected with the hand controller)
D: FST for right foot (It is connected with the foot controller)
E: FST for left foot (It is connected with the foot controller)

What is claimed is:

1. Multi-joint structure wherein it is constituted to output moving quantity and vector when the joint unit move to translate and rotate by detecting variation of the connecting parts between the joints at real time when shape of the multi-joint structure is deformed, constituted so that variation detection sensor such as potentiometers is provided on connecting parts between each of joints, one or a plurality of the sensors are assumed to be a unit of the group, the signals of the sensors are captured by signal processing parts in each unit of the group, the signal processing parts are connected to the communication network and the operation processing part connected to the communication network computes and processes in accordance with signal data of the sensors, to manually and optionally change length of a multi-joint structure.

2. The multi-joint structure according to claim 1, wherein the structure is composed by tubular or cylindrical shape, and comprises the power line and/or the signal line internally.

3. The multi-joint structure according to claim 1, wherein the structure comprises the circuit pattern of the power line and the signal line in a surface or an inside layer.

4. In the multi-joint structure according to claim 1, wherein the joint unit block consisting of 1 or plural joint units comprises the recognition function of self-ID in the entire system.

5. The multi-joint structure according to claim 1, wherein the joint unit comprises Light Emitting Diode, and operation and the state of the sensor can be observed from the outside.

6. The multi-joint structure according to claim 1, wherein the joint unit comprises the rotation mechanism.

7. The multi-joint structure according to claim 1, in combination with a mounting tool incorporating the multi-joint structure.

8. The mounting tool combination according to claim 7, wherein filter processing to nullify minute change of human body at the time of equipping a human body with it is comprised in operation processing part.

9. The multi-joint structure according to claim 1, in combination with a mounting tool incorporating the multi-joint structure, wherein both hands, both legs, and the head respectively, can measure in real time each position and each operation of both hands, both legs, and the head, from a position of standard device attached to the waist or the back and from whole shape of multi-joint structure.

10. The multi-joint structure according to claim 1, in combination with a mounting tool that is equipped with the multi-joint structure in arm, and in real time measures moving operation of arm from a position of standard device attached to movable body including at least wheelchair and whole shape of multi-joint structure, and is able to control movable body.

11. The multi-joint structure according to claim 4, in combination with a mounting tool incorporating the multi-joint structure, wherein both hands, both legs, and the head respectively, measure in real time each position and each operation of both hands, both legs, and the head, from a position of standard device attached to the waist or the back and from whole shape of multi-joint structure, and use the measurement data as data for rehabilitation or data for training, and can move connected part of the above-mentioned multi-joint structure according to the difference with the target value data.

12. The multi-joint structure according to claim 1, in combination with a mounting tool, wherein a finger is equipped with the multi-joint structure and each inputs, such as a keyboard input, can carry out.

13. The multi-joint structure according to claim 1, in combination with a mounting tool equipping an arm and a finger with the multi-joint structure, and the combination is able to perform technique of an operation by remoteness.

14. The multi-joint structure according to claim 1, in combination with a medical device, wherein the multi-joint structure is equipping a medical device used for technique of an endoscope with the multi-joint structure, and performing position recognition of medical device.

15. The multi-joint structure according to claim 4, in combination with planar structure, wherein plural multi-joint structures are arranged and the planar structure is composed.

16. The combination according to claim 15, in combination with a solid structure making a flat surface of planar structure crooked, and being able to form a solid when a connecting part of multi-joint structure which constitutes the planar structure moves by power means.

17. The multi-joint structure according to claim 1, in combination with a movable body connected with the controller of the shipboard by the multi-joint structure, having the transportation such as propellers that surface, subside in water, or move front, back, left and right, the system can control for target position moving movable body by in real time identifying position and operation of movable body, and can do data communication and power supply to movable body.

18. The combination system according to claim 17 wherein investigation of a ship's bottom without raising movable body to dock of ship or basic assembly work in the bottom of water can be done, movable body comprises at least camera, sensor, and arm.

19. The multi-joint structure according to claim 1, in combination with a human machine interface wherein the above-mentioned movable body may be operated with the mounting tool incorporating the multi-joint structure, wherein parts of a human body namely both hands, both legs, the head, and a finger respectively, can measure in real time each position and each operation of each part of a human body, from a position of standard device attached to containing the waist, the back, or a robot and from whole shape of multi-joint structure.

20. The multi-joint structure according to claim 1 wherein the joint unit is covered with the hull corresponding to the necessity like the waterproof, dustproof, and fire prevention, and it was added at the same time by the means to fix the hull.
